(19) United States
(12) Patent Application Publication
(10) Pub. No.: US 2016/0364992 A1
(43) Pub. Date: Dec. 15, 2016

(54) TEACHING AID USING PREDICTED PATTERNS IN SPELLING ERRORS

(71) Applicant: International Business Machines Corporation, Armonk, NY (US)

(72) Inventors: Lakshminarayanan Krishnamurthy, Round Rock, TX (US); Niyati Parameswaran, Austin, TX (US); Edward E. Seabolt, Round Rock, TX (US); Paul T. Wright, Austin, TX (US)

(21) Appl. No.: 14/739,079

(22) Filed: Jun. 15, 2015

(51) Int. Cl. G09B 5/00; G09B 19/00

(52) U.S. Cl. CPC G09B 5/00; G09B 19/00

(57) ABSTRACT

Teaching aid for improving the spelling competency of a student. The framework provides differentiated instruction and tailors interventions specific to the needs of the student by taking into account relative performance of peers and the root cause of an identified spelling error.

### BACKGROUND

The present invention relates generally to the field of analytics, and more particularly to teaching aids.

Spelling is one of the fundamental sub-skills of effective written communication. The acquisition of spelling rules is a complex developmental process. People commonly tend to make errors when writing. Spelling errors, as discussed herein, are organized according the following categories: (i) errors stemming from incorrect typography; (ii) errors originating from poor language or deficient literacy; and (iii) errors arising due to cases of learning disabilities like dyslexia or dysgraphia.

Word processors play a significant role in handling most of the spelling errors caused by the three categories listed above. Word processors support persons while they write, for example, emails, instant messages, and even blogs. Standard features of many state-of-the-art word processors include spelling and grammar checks, built-in thesaurus capability, and automatic text correction. Word processors are indispensable tools that make spelling corrections when using a computer a trivial task.

Conventionally, spelling software programs, also referred to as “spellers,” either correct a misspelled word or generate potential suggestions for the misspelled word by testing the written words against a dictionary of known words. More advanced spellers use phonetic spell checking and produce a list of candidate words that may have different spellings, but are homonyms to the misspelled word. There is a large amount of literature that focuses on improving the accuracy and the capabilities of automated spell checkers.

### SUMMARY

In one aspect of the present invention, a method, a computer program product, and a system includes: assigning a first set of root causes to a first error type of a set of error types, monitoring a spelling event of a user for a misspelled word based, at least in part, on a set of target words, determining that the misspelled word is a misspelling of a target word of a set of target words according to the first error type, generating a set of training words based, at least in part, on a characteristic of the target word, and selecting from the set of training words, a set of focus words based, at least in part, on the first set of root causes.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a diagram showing a diagnostic framework helpful in understanding some embodiments of the present invention; and

FIG. 5 is a diagram showing example word analysis according to some embodiments of the present invention.

### DETAILED DESCRIPTION

Teaching aid for improving the spelling competency of a student. The framework provides differentiated instruction and tailors interventions specific to the needs of the student by taking into account relative performance of peers and the root cause of an identified spelling error. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

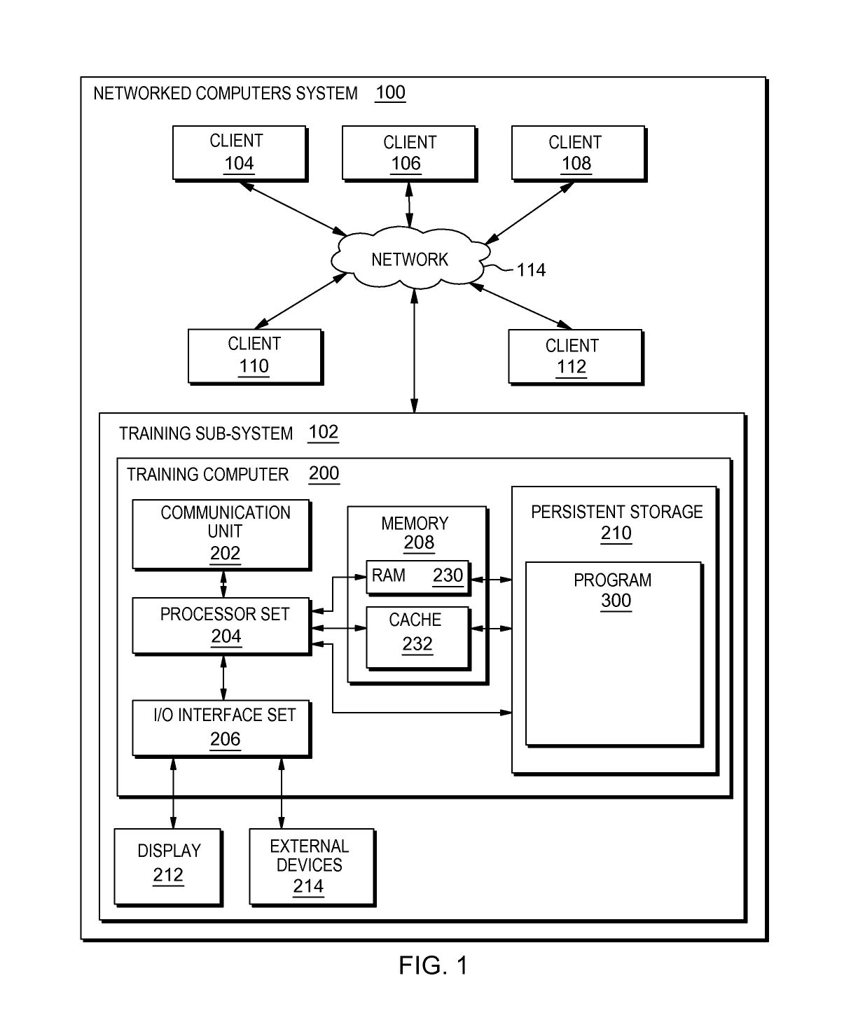

The present invention will now be described in detail with reference to the Figures. FIG. 1 is a functional block diagram illustrating various portions of networked computers system 100, in accordance with one embodiment of the present invention, including: training sub-system 102; client sub-systems 104, 106, 108, 110, 112; communication network 114; training computer 200; communication unit 202; processor set 204; input/output (I/O) interface set 206; memory device 208; persistent storage device 210; display device 212; external device set 214; random access memory (RAM) devices 230; cache memory device 232; and spelling program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Spelling support program 300 operates to both extrapolate the conventional usage of a spell checker and to tailor interventions that serve to improve the spelling competency of the user in a specific and thorough way. Tailored interventions executed through a diagnostic framework can be integrated as a cognitive application fueled by cognitive computing technology in fields such as education to work through the root cause(s) of spelling errors to recommend actions. In some embodiments, the root cause analysis and corresponding actions are determined in light of spelling error categories, such as those provided in the Background Section of this Specification.

Some embodiments of the present invention recognize the following facts, potential problems and/or potential areas for improvement with respect to the current state-of-the-art: (i) conventional spelling software programs lack the ability to determine the cause of a spelling error; (ii) conventional spelling software programs use a binary classification scheme for spelling correction; and/or (iii) it is prudent to exploit the fact that every spelling error in English can be derived only on the basis of certain operations on the letter(s) that form a given word.

Some embodiments of the present invention could be utilized to effectively train students to correctly spell words in languages other than English.

It should be noted that some embodiments of the present invention apply to a language instruction guide for persons learning English as a non-native language. For example, writing samples from these persons are used to gauge the user's progress with acquiring proficiency in English. Accordingly, a set of words is generated based on the misspellings identified in the writing sample to better focus assistance to the user's specific language proficiency.

Every spelling error in English can be caused by operations on the letter(s) that form a given word. The operations are insertion(s), deletion(s), swap(s), and/or replacement(s). The Damerau-Levenshtein distance is a string metric computed by counting the minimum number of operations needed to transform a first string into a second string. For example, the target word “slow” may be incorrectly spelled as “slo” in a deletion operation, where the letter “w” is deleted. The target word “camel” may be incorrectly spelled as “cammel” in an insertion operation of the letter “m.” The target word “ginger” may be incorrectly spelled as “jinger” in a replacement operation of the letter “g” with the letter “j.” The target word “friend” may be incorrectly spelled as “freind” in a swap operation of the letters “I” and “e.” The target word “talk” may be incorrectly spelled as “tok” where multiple operations are involved.

The Demerau-Levenshtein distance between two strings a and b is given by the following formula:

$${d}_{a , b} ( \vert a \vert , \vert b \vert ) , \\ where \text{:}$$

$${d}_{a , b} ( i , j ) = \{ \begin{matrix}max ( i , j ) & if min ( i , j ) - 0 , \\ min \{ \begin{matrix}{d}_{a , b} ( i - 1 , j ) + 1 \\ {d}_{a , b} ( i , j - 1 ) + 1 \\ {d}_{a , b} ( i - 1 , j - 1 ) + {1}_{( {a}_{i} \neq {b}_{j} )} \\ {d}_{a , b} ( i - 2 , j - 2 ) + 1\end{matrix} & \begin{matrix}if i , j > 1 and \\ {a}_{i} = {b}_{j - 1} and \\ {a}_{i - 1} = {b}_{j}\end{matrix} , \\ min \{ \begin{matrix}{d}_{a , b} ( i - 1 , j ) + 1 \\ {d}_{a , b} ( i - 1 , j ) + 1 \\ {d}_{a , b} ( i - 1 , j - 1 ) + {1}_{( {a}_{i} \neq {b}_{j} )}\end{matrix} & otherwise ,\end{matrix}$$

where 1₍ₐ_{ᵢ}_{≠b}_{ⱼ}₎ is the indicator function equal to 0 when aᵢ=bⱼ and equal to 1 otherwise.

Each recursive call matches one of the cases covered by the Damerau-Levenshtein distance:
d_{a,b}(i−1,j)+1 corresponds to a deletion (from a to b);
d_{a,b}(i,j−1)+1 corresponds to an insertion (from a to b);
d_{a,b}(i−1, j−1)+1₍ₐ_{ᵢ}_{≠b}_{ⱼ}₎ corresponds to a match or mismatch, depending on whether the respective symbols are the same; and
d_{a,b}(i−2, j−2)+1 corresponds to a transposition between two successive symbols.

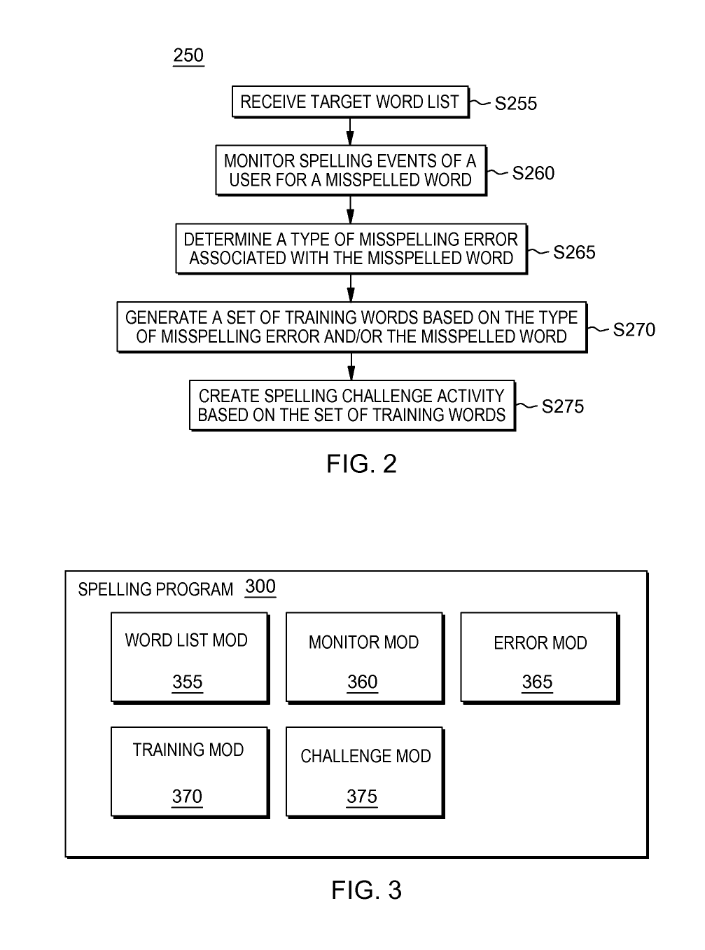

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

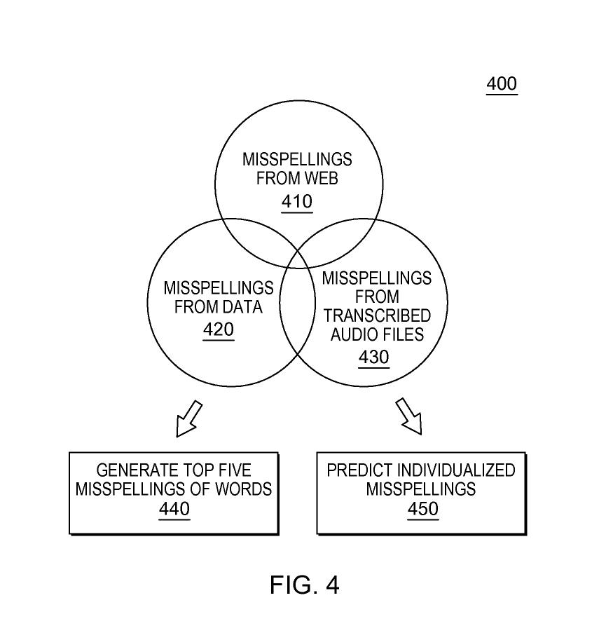

Processing begins at step S255, where word list module “mod” 355 receives a target word list. In this example, there is a set of target words for students to learn during a period of training. These words are pre-determined according to a selected course curriculum. One of the words is “sitting.” Alternatively, the word list is a collection of words obtained from selected websites. Alternatively, the word list represents words used in a particular set of documents stored in a database. Further discussion and more details regarding sources from which the word list is prepared is found below, particularly with respect to FIG. 4.

Processing proceeds to step S260, where monitor mod 360, monitors spelling events of a user to identify a misspelled word in the word list received in step S255. The term spelling events is used broadly herein to include a variety of spelled word inputs that may be generated by a user while demonstrating proficiency in spelling. In this example, the spelling event occurs as the user enters words into a conventional word processor for a homework assignment to write about a selected topic. Accordingly, a spelling event occurs each time a word is written. In that way, monitoring occurs during the writing process in a manner that may be referred to as in real-time. Alternatively, the monitor mod reviews a completed written document, where the document is a single spelling event.

Continuing with the example, monitor mod 360 detects a misspelled word arising from the spelling event while monitoring a spelling event. In this example, the monitor mod detects that the word “sitting” is misspelled.

Processing proceeds to step S265, where error mod 365 determines a type of misspelling error associated with the misspelled word. Some types of misspelling errors are discussed below. In this example, error types are identified by comparing a correctly spelled word with the misspelled word. Accordingly the error types are relative to the correct spelling. For example, misspelling error types include: (i) deletion; (ii) insertion; (iii) replacement; and/or (iv) swapping. In this example, the word “sitting” is spelled “siting.” It can be seen that this misspelling error type reflects the deletion-type of misspelling in that a letter “T” is missing from the misspelled word. As discussed further below, there are several root causes for spelling errors including: (i) dyslexia; (ii) dysgraphia; (iii) rote visual; (iv) memory; (v) semi-phonetic; (vi) word morphology; (vii) typography; (viii) language skill; (ix) literacy; and/or (x) homonym. These root causes are associated with one or more of the above-listed misspelling error types.

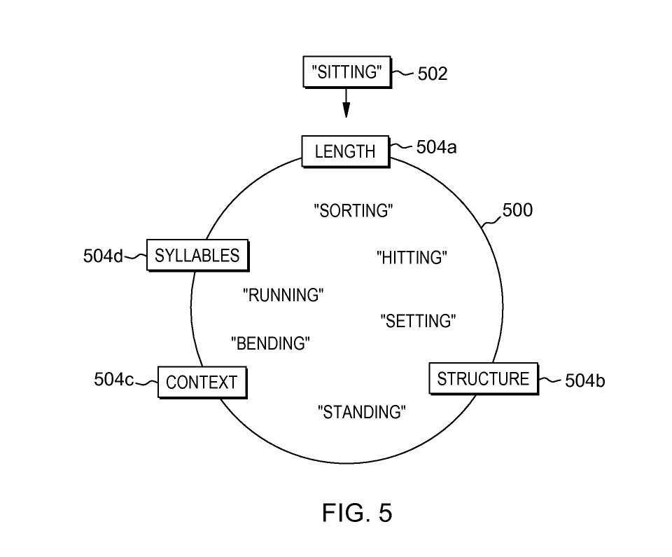

Processing proceeds to step S270, where training mod 370 generates a set of training words based on the type of misspelling error and/or characteristics of the misspelled word. In this example, training words are identified from within the target word list. Alternatively, training words are extracted from websites and/or from a set of selected documents in a database. As described in detail with reference to FIG. 5 below, word characteristics include: (i) length; (ii) school grade level; (iii) structure; (iv) context; and/or (v) syllables. Continuing with this example, the set of training words generated for the word “sitting” are sorting, hitting, setting, standing, bending, and running.

Additionally, the selection of the set of training words, in some embodiments of the present invention, is for the purpose of determining a root cause of the misspelled word. That is, the type of misspelling error and/or characteristics of the misspelled word are used to indicate which of the root causes to focus on and/or which of the root causes to dismiss from consideration. The selection of a word having particular characteristics may be made in view of which root causes are being considered. For example, if the root cause of poor language skills or deficient literacy is being considered, the set of training words will focus, at least in part, on word characteristics such as context and/or structure.

Alternatively, training words are selected in accordance with the school grade level, or development stage, of a child during the language acquisition process. The type(s) of errors in the child's misspellings with respect to the training words are analyzed for use in generating future test words. The future test words tend to result in similar types of errors as the one(s) made by the child during earlier training. In some embodiments of the present invention, the test words are rendered in accordance with the grade level, development stage, and/or level of language proficiency of the child.

Processing proceeds to step S275, where challenge mod 375 creates a spelling challenge activity based on the set of training words. Some embodiments of the present invention create a story that includes some or all of the training words. In that way, the story may be read aloud to the user, who writes down what is said. The story telling approach provides for a rich context clue environment. Alternatively, the training words are simply generated in a list that is provided to an instructor, who provides each word to the user as a spelling test. Further, some embodiments of the present invention monitor the writing activity or spelling exam while it is being performed as a set of spelling events for processing according to step S260 and S265.

Further embodiments of the present invention are discussed in the paragraphs that follow and later with reference to FIGS. 4 and 5.

Some embodiments of the present invention build upon a conventional spell checker to use the flagged misspellings and suggested corrections to align a particular child's misspelled characters with the corresponding letters in the correctly spelled target word, thereby tracking the type of error that a user made when spelling the target word as opposed to just flagging it as incorrect on the basis of a rigid binary classification scheme.

Some embodiments of the present invention are deployed having a series of hash functions that successfully map all potential misspellings of a target word to the correctly spelled target word through a Bloom filter implementation. The principle is premised on a reverse lookup that not only elucidates the cause of the spelling error (as illustrated earlier), but also predicts a sense of “commonality in the misspellings” by correlating the misspellings the child has a tendency to make (Domain 1) to the misspellings that similarly-situated children, for example, a similar age-group, make generated by associating probabilistic percentages for every word (Domain 2).

The overlap between Domains 1 and 2 is computed through a TF-IDF (term frequency-inverse document frequency) score. A relatively large overlap between Domains 1 and 2 serves to support the commonality of the child's misspelling. However, relatively little overlap, or a predetermined level of distinction, between the two domains indicates an uncommon pattern in misspellings with respect to the similarly-situated children. This condition is of particular interest to a “spelling buddy” embodiment that captures the individuality in misspellings and feeds in a value into the Bloom filter derived from the parallel drawn against the two domains.

An example Bloom filter k-mer counting algorithm follows:

```
B ← empty Bloom filter of size m
T ← hash table
for all reads δ do
  for all k-mers [symbol]     in δ do [symbol]
    ᵣₑₚ ← min( [symbol]   , revcomp( [symbol]   ))// [symbol]    ᵣₑₚ is the canonical k-mer for [symbol]
    if [symbol]    ᵣₑₚ ∈ B then
      if [symbol]    ᵣₑₚ ∉ T then
        T[ [symbol]   ᵣₑₚ] ← 0
    else
      add [symbol]    ᵣₑₚ to B
for all reads δ do
  for all k-mers [symbol]     in δ do [symbol]
    ᵣₑₚ ← min( [symbol]   , revcomp( [symbol]   ))
    if [symbol]    ᵣₑₚ ∈ T then
      T[ [symbol]   ᵣₑₚ] ← T[ [symbol]   ᵣₑₚ] + 1
for all [symbol]     ∈ T do
  if T[ [symbol]   ] = 1 then
    remove [symbol]     from T
```

Through the execution of this embodiment, the type of spelling errors are highlighted, such as a repeated transposition pattern, incorrect single/double letter usage, phonetic misspelling, or an erroneous intra-word pattern, but the orthography and morphology are correlated back through a K-means clustering algorithm that groups words of higher similarity (lower edit distance) by using word length, number of syllables, word structure (pre-fix, suffix), and word context as primary features. The feedback garnered from the assessment described above (especially in the case of too many uncommon misspellings) is deliberately sequenced in a manner that propels the child's development. The execution as described herein works off of a ranked word learning model that analyzes the misspellings and uses linguistic, orthographic, and morphologic characteristics of the misspellings to generate a set of words bearing a similar word structure to the misspellings, particularly the uncommon misspellings, made by the child.

In the discussion that follows, small children are used as exemplary users. However, it should be noted that embodiments of the present invention are directed to users of various ages and/or levels of development. Children move through varied and distinct developmental stages as they acquire spelling skills. What begins as an ability to recognize alphabets and their respective sounds, develops into finding patterns within words and gradually progresses to being able to string words together to form a structurally and semantically coherent sentence. These different stages that children experience in the process of learning and/or writing words are often reflected by certain patterns that arise in their spelling. Some embodiments of the present invention look to certain unique patterns in spelling that are suggestive of the child's progress in the process of internalizing language. In that way, support is provided for spelling development and language acquisition through chartered individualized plans built off differentiated instruction.

There is a close association of work being performed with cognitive computing pillars. The application of cognitive computing in this description serves to emphasize the adaptive nature of that platform and highlights the usefulness of a cognitive computing service as a language acquisition buddy for children who tend to have varied trajectories when it comes to acquiring proficiency in language.

Some embodiments of the present invention learn the misspellings made by a given child and perceive the cause of the misspellings as opposed to merely recording the spelling as correct or incorrect based solely on a rigid binary classification scheme, such as one used in conventional spell checkers. The misspellings made by a child are related to the misspellings made by other children in a similar age group to infer the commonality of the misspellings and to determines a trend in the misspellings by differentiating the unique misspellings made by the child from the common misspellings made by similarly situated children.

Some embodiments of the present invention adapt the language training process according to a child's current stage in language proficiency. For example, a new list of words is generated that not only includes the misspellings the child has made, but also includes words of similar orthographic structure to the misspellings the child made in order to provide the child with spelling instruction to specifically improve the language development of the child.

Some embodiments of the present invention implement a workflow step through a series of individual steps, with every intermediate step focused at improving the functionality of a “spelling buddy” for children who are yet to acquire proficiency in language. The hypothesis is to tailor instruction suited to the child's spelling competency through consistent positive reinforcement with the child being motivated to make progress at the child's own pace without any rigid expectations. Further, some embodiments of the present invention provide relative assessments by comparing the child's progress with the average progress of other children of similar age-groups. Additionally, in some embodiments, selected words are identified that the child demonstrates a tendency to misspell so that rewards are provided to the child for improvements with the selected words. The described methodology ties in closely with the four pillars of a cognitive platform. The functionality of some embodiments of the present invention may be broadly classified under two categories: (i) learning and perceiving; and (ii) relating and reasoning.

The category of learning and perceiving is invoked by flagging a misspelled word with respect to a target word and gaining perspective on a pattern in the misspelling and/or a type of error that presents itself when comparing a misspelled word with a correctly spelled word, or target word. The category of relating and reasoning is invoked by utilizing a principle that finds its origin in a reverse look up to intuitively ascertain why the word that has been typed in is incorrect, differentiating between spelling patterns that a child can and cannot recognize by aligning the average child's progress in spelling development to the individual caliber of the child, and using the insight gained during the process to build a word knowledge base that augments spelling, word recognition, vocabulary, phonics, and reading skills in children.

FIG. 4 shows process flow 400 for analyzing misspellings according to some embodiments of the present invention. Process 400 takes into account misspellings obtained from various sources including: misspellings from websites 410; misspellings from data sources 420; and misspellings from transcribed audio files 430, such as the corpus developed by LumiDaOn. (Note: the term(s) “LumiDaOn” may be subject to trademark rights in various jurisdictions throughout the world and are used here only in reference to the products or services properly denominated by the marks to the extent that such trademark rights may exist.) Transcribed audio files are used to identify common variations in misspellings based on the approach that children tend to spell words through letter-sound correspondences, so their manner of saying a word would tend to likely match the way that the word is spelled. These misspellings are used to generate a set of the top five misspellings of certain words 440. Further, the misspellings considered in process 400 are used to predict individualized misspellings 450 according to, for example, similar types of misspelling error(s).

Some embodiments of the present invention improve both reading and writing skills of children and use the implicit relationship between each of these skill sets to provide a differentiated language instruction that is adapted to every child.

Some embodiments of the present invention ensure that the instruction provided is individualized, the model biases itself to the misspellings a child continues to make to increase the probability of displaying not only the misspelled word, but also other words that belong in the same cluster as the misspelled word. Accordingly, the child not only gains an understanding of the type of misspellings that the child tends to make, but is also exposed to other words that bear similar word structure to word that the child tends to misspell.

Some embodiments of the present invention generate a set of probabilistic percentages for common misspellings of a given word. For example, the set of probabilistic percentages for misspelling the word “obvious” may be as follows:

TABLE 1
Analysis of misspellings of the word “obvious.”

| MISSPELLING OF | PERCENTAGE OF |
|---|---|
| “OBVIOUS” | MISSPELLINGS |
| OBVIUS | 60 |
| OBVIUZ | 16 |
| OBVIUOS | 12 |
| OBVIOAS | 6 |
| OBEOUS | 6 |

Some embodiments of the present invention build word knowledge bases by grouping words of similar orthographic structure as a keyword. In FIG. 5, word knowledge base 500 is shown based on the keyword “sitting” 502. The word knowledge base includes certain orthographic structure groups associated with the keyword. In this example, the orthographic structure groups are length 504a, structure 504b, context 504c, and syllables 504d. Alternative groupings are used according to various embodiments of the present invention. In this example, a set of words is shown in knowledge base 500, including: sorting, hitting, setting, standing, bending, and running. According to some embodiments of the present invention, orthographic features include: (i) spelling; (ii) hyphenation; (iii) capitalization; (iv) word breaks; (v) emphasis; and/or (vi) punctuation. The words illustrated in FIG. 5 are similar for various and multiple structure groups. For example, the word “standing” has more letters (length) than the target word, but in contextually opposite of the target word (context), while it has a similar structure in that it ends in the letters “ing” (structure). Among the other words shown, the words “hitting” and “setting” each have double t's in the spelling (structure), similar to the target word, “sitting.” Each word shown has the same number of syllables as the target word.

Some embodiments of the present invention use standardized, well-established rules to ascertain the nature of a misspelling error by aligning the misspelled characters in the words to the letters in the correctly spelled target word. Some embodiments of the present invention rely on implicit learning as they work with a vocabulary engine to generate other words bearing similar word structure to the words that are misspelled. In that way, the language instruction is tailored to work in accordance with the stage at which the child, or other user, is at when acquiring language proficiency. In some embodiments of the present invention, a medical practitioner is contacted where a feature of misspellings is determined to be representative of dyslexia/dysgraphia.

Some embodiments of the present invention identify factors associated with spelling errors to identify types of errors and perform automatically an action based on the type of error detected. The action includes monitoring a plurality of users entering text into a system for spelling errors, classifying spelling errors according to rules to associate patterns of errors with types of error, and, responsive to detecting a type of error and characteristics of a user, constructing an augmented word knowledge and utilizing the augmented word knowledge base to perform automatically an action based on the type of error and the characteristics of the user wherein the action is at least one of educational (instructional), predictive (informational), and corrective (identifying correctly spelled words). In some embodiments, the characteristics of the user are selected from a group consisting of demography, age, language exposure, and education. In some embodiments, the root cause of a spelling error is selected from a group consisting of dyslexia, dysgraphia, rote visual memory, semi-phonetic, word morphology, typography, language skill, literacy, and homonym.

Some embodiments of the present invention may include one, or more, of the following features, characteristics and/or advantages: (i) identification of misspelled words; (ii) provision of corrective recommendations; (iii) analysis of these misspellings to derive common error patterns; (iv) establishment of the significance of grammatical errors to rote visual memory; (v) establishment of the significance of grammatical errors to semi-phonetic representations; (vi) establishment of the significance of grammatical errors to word morphology; (vii) understanding the misspellings users, such as children, make as they discover the intricacies of English orthographic system; (viii) usage of historic misspellings of a user as a future spelling instruction guide to provide differentiated instruction as the user acquires language as a skill; (ix) boosting language acquisition rates; (x) provision of a spelling solution through a language model that uses a graded relevance for spelling correction; (xi) intelligent determination of the word sets to be given to users as part of a thoughtful spelling improvement strategy; (xii) generation of a new word list in accordance with the user's prior mispronunciations; and/or (xiii) generation of a new word list in accordance with the user's prior misspellings.

Some embodiments of the present invention may include one, or more, of the following features, characteristics and/or advantages: (i) provision of tailored instruction are provided according to the user's weakness(es) in language comprehension; (ii) drawing a correlation between the user's writing and reading skills; (iii) alignment of the misspelled characters with the corresponding letters in a correctly spelled target word; (iv) identification of the cause of a misspelling event by tracking the type of error; (v) recognition of a trend in the misspelling events based on multiple writing samples of the same user; (vi) identification of the cause of the misspelling as opposed to just highlighting it; (vii) identification of whether a given child has a tendency to delete characters from words; (viii) identification of whether a child has a tendency to swap consecutive vowels when spelling a word; (ix) every child is provided with spelling instruction that matches their caliber at comprehending letter-sound correspondences, syllable patterns, and/or morpheme patterns; (x) distinguishing between generalizations and exceptions in English language; and/or (xi) entirely automated as to deciphering the causality of misspellings and associated intrinsic trends in misspellings.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
assigning a first set of root causes to a first error type of a set of error types;
monitoring a spelling event of a user for a misspelled word based, at least in part, on a set of target words;
determining that the misspelled word is a misspelling of a target word of a set of target words according to the first error type;
generating a set of training words based, at least in part, on a characteristic of the target word; and
selecting from the set of training words, a set of focus words based, at least in part, on the first set of root causes;
wherein:
at least the determining, generating, and selecting steps are performed by computer software running on computer hardware.

2. The method of claim 1, wherein the step of generating a set of training words is further based on a characteristic of the user.

3. The method of claim 1, wherein the spelling event is a spelling by the user of a single word while using a word processor.

4. The method of claim 3, wherein the monitoring step is performed by the word processor.

5. The method of claim 1, further comprising:
deriving the set of error types from a comparison of a correct letter placement with an incorrect letter placement of the misspelled word.

6. The method of claim 5, wherein the first error type is where the comparison of the correct letter placement with the incorrect letter placement of the misspelled word is one of an insertion, a swap, or a combination of the two.

7. The method of claim 1, further comprising:
collecting the set of target words from documents found on the internet.

8. The method of claim 1, further comprising:
creating a spelling challenge activity that incorporates at least some of the focus words from the set of focus words.

9. A computer program product comprising a computer readable storage medium having stored thereon:
first program instructions programmed to assign a first set of root causes to a first error type of a set of error types;
second program instructions programmed to monitor a spelling event of a user for a misspelled word based, at least in part, on a set of target words;
third program instructions programmed to determine that the misspelled word is a misspelling of a target word of a set of target words according to the first error type;
fourth program instructions programmed to generate a set of training words based, at least in part, on a characteristic of the target word; and
fifth program instructions programmed to select from the set of training words, a set of focus words based, at least in part, on the first set of root causes.

10. The computer program product of claim 9, wherein generating a set of training words is further based on a characteristic of the user.

11. The computer program product of claim 9, wherein the spelling event is a spelling by the user of a single word while using a word processor.

12. The computer program product of claim 9, further comprising:
sixth program instructions programmed to derive the set of error types from a comparison of a correct letter placement with an incorrect letter placement of the misspelled word.

13. The computer program product of claim 9, further comprising:
sixth program instructions programmed to create a spelling challenge activity that incorporates at least some of the focus words from the set of focus words.

14. A computer system comprising:
a processor(s) set; and
a computer readable storage medium;
wherein:
the processor set is structured, located, connected, and/or programmed to run program instructions stored on the computer readable storage medium; and
the program instructions include:
first program instructions programmed to assign a first set of root causes to a first error type of a set of error types;
second program instructions programmed to monitor a spelling event of a user for a misspelled word based, at least in part, on a set of target words;
third program instructions programmed to determine that the misspelled word is a misspelling of a target word of a set of target words according to the first error type;
fourth program instructions programmed to generate a set of training words based, at least in part, on a characteristic of the target word; and
fifth program instructions programmed to select from the set of training words, a set of focus words based, at least in part, on the first set of root causes.

15. The computer system of claim 14, wherein generating a set of training words is further based on a characteristic of the user.

16. The computer system of claim 14, wherein the spelling event is a spelling by the user of a single word while using a word processor.

17. The computer system of claim 14, further comprising:
sixth program instructions programmed to derive the set of error types from a comparison of a correct letter placement with an incorrect letter placement of the misspelled word.

18. The computer system of claim 14, further comprising:
sixth program instructions programmed to create a spelling challenge activity that incorporates at least some of the focus words from the set of focus words.
